(19) United States
(12) Patent Application Publication
(10) Pub. No.: US 2022/0379317 A1
(43) Pub. Date: Dec. 1, 2022

(54) DEHYDRATION AND UPGRADING SYSTEM FOR HIGH-WATER-CONTENT MATERIAL

(71) Applicants: China University of Mining and Technology, Xuzhou City (CN); Jiangsu Hydrocarbon Clean Energy TechRschInstCoLtd, Xuzhou City (CN)

(72) Inventors: Bo Zhang, Xuzhou City (CN); Guanghui Yan, Xuzhou City (CN); Zhenxing Zhang, Xuzhou City (CN); Junwei Guo, Xuzhou City (CN); Linsheng Gong, Xuzhou City (CN); Mengyao Guo, Xuzhou City (CN)

(21) Appl. No.: 17/659,225

(22) Filed: Apr. 14, 2022

(30) Foreign Application Priority Data
May 29, 2021 (CN) 202110595666.6

(51) Int. Cl. B03B 9/00; C10L 1/32

(52) U.S. Cl. CPC B03B 9/005; C10L 1/326; C10L 2200/0295; C10L 2290/58; C10L 2290/08

(57) ABSTRACT

The present disclosure provides a dehydration and upgrading system for a high-water-content material, including a reaction kettle, a steam generator and a steam recovery apparatus, wherein the steam generator and the steam recovery apparatus are located at left and right sides of the reaction kettle respectively, and are connected through steam pipelines; a pressure sensing device is arranged on the reaction kettle to sense the pressure therein; a feed port is formed at an upper end of the reaction kettle; a discharge port is formed at a lower end of the reaction kettle; a discharge conveying belt is arranged below the discharge port; a high-pressure air pipe is arranged on one side of the middle part of the reaction kettle; and a high-pressure air valve is arranged on the high-pressure air pipe.

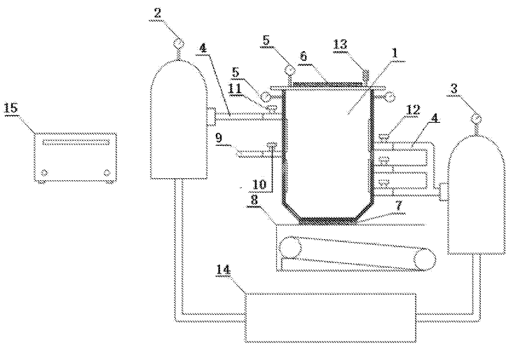

### CROSS REFERENCE TO RELATED APPLICATION(S)

This patent application claims the benefit and priority of Chinese Patent Application No. 202110595666.6 filed on May 29, 2021, the disclosure of which is incorporated by reference herein in its entirety as part of the present application.

### TECHNICAL FIELD

The present disclosure relates to the technical field of dehydration and upgrading of slime coal, particularly to a dehydration and upgrading system for a high-water-content material.

### BACKGROUND ART

In daily production and life, there are usually high-water-content materials to be treated, such as high-water-content concentrates in mineral separation products, high-water-content foods in food processing, etc. In order to meet the needs of smelting or other processing departments, it is necessary to remove water from materials. At present, traditional product dehydration methods in China mostly adopt an external heating dehydration process, which has the disadvantages such as low dehydration efficiency and easy spontaneous combustion of products during dehydration. Currently, avoiding the spontaneous combustion of materials and improving the material dehydration efficiency are key issues in the dehydration technology of mineral processing.

### SUMMARY

In order to overcome the shortcomings existing in the art, the present disclosure provides a dehydration and upgrading system for a high-water-content material. The dehydration and upgrading reaction is carried out through a reaction kettle. The high-temperature and high-pressure steam which is produced by a steam generator is pumped into the reaction kettle. The moisture of the minerals is removed in two forms: flash evaporation and seepage flow; and the explosion energy breaks pore structures and prevents readsorption of water at the same time. The reaction kettle is provided with a temperature sensing device and a pressure sensing device, and the temperature and pressure in the reaction kettle can be monitored in real time respectively. A pressure relief valve of the high-pressure reaction kettle adopts a special valve that can quickly release saturated steam in an instantaneous state, so as to reduce the pressure and temperature in the system and ensure the dehydration effect.

The present disclosure provides a dehydration and upgrading system for a high-water-content material, including a reaction kettle, a steam generator and a steam recovery apparatus, wherein the steam generator and the steam recovery apparatus are located at left and right sides of the reaction kettle respectively, and are connected through steam pipelines; a pressure sensing device is arranged on the reaction kettle to sense the pressure therein; a feed port is formed at an upper end of the reaction kettle; a discharge port is formed at a lower end of the reaction kettle; a discharge conveying belt is arranged below the discharge port; a high-pressure air pipe is arranged on one side of the middle part of the reaction kettle; and a high-pressure air valve is arranged on the high-pressure air pipe.

In a further development, an air intake valve is arranged on the part of the steam pipelines on the steam generator side, and a pressure relief valve is arranged on the part of the steam pipelines on the steam recovery apparatus side.

In a further development, the feed port and the discharge port are provided with air-tight plugs for increasing the airtightness of the feed port and the discharge port respectively.

In a further development, a temperature sensor is arranged on the reaction kettle to detect the temperature therein.

In a further development, the number of the part of the steam pipelines on the steam recovery apparatus side is at least two, and each of the part of the steam pipelines on the steam recovery apparatus side is provided with the pressure relief valve.

In a further development, an exhaust gas purification device is arranged between the steam generator and the steam recovery apparatus, and the steam recovered in the steam recovery apparatus is treated through the exhaust gas purification device and is then conveyed to the steam generator for recycling.

In a further development, an electric control system is arranged near the reaction kettle, and the electric control system controls each component.

Beneficial effects of the present disclosure are as follows: the process of releasing from a high pressure to a low pressure within the reaction kettle is transient, and thus the pressure and temperature differences between the coals inside and the outside are increased, so that the coal moisture is removed in two forms of flash evaporation and seepage flow, and the explosion energy breaks the pore structures and prevents the readsorption of water at the same time. The feed port at the upper end and the discharge port at the lower end of the high-pressure reaction kettle are both provided with high-pressure sealing devices to satisfy the sealing property and the safety during operation of the equipment under high-temperature and high-pressure conditions. Sealing valves connected between different platforms have higher airtightness and need to be closed during dehydration. Air-tight plugs are arranged at an inlet of a feeding platform and an outlet of a discharging platform. The air-tight plugs are opened during feeding and discharging respectively, and are hermetically closed during operation of the equipment. The high-pressure reaction kettle is provided with the temperature sensing device and the pressure sensing device, which can monitor temperature and pressure in the reaction kettle in real time respectively. The pressure relief valve of the high-pressure reaction kettle adopts a special valve that can quickly release saturated steam in an instantaneous state, so as to reduce the pressure and temperature in the system and ensure the dehydration effect. High-pressure air used by the discharging platform shall have high drying property, and protective gas is used to prevent spontaneous combustion of slime coal. A steam recovery device has good heat insulation property and can effectively keep waste heat generated by the system. The recovered steam returns to a steam generation system to realize recycling of the steam, which reduces the overall energy consumption. An exhaust gas purification device can effectively filter out materials and dissolved ions brought out by the steam to ensure the purity of the steam.

### BRIEF DESCRIPTION OF THE DRAWINGS

The drawing is a schematic structural diagram of the present disclosure.

In the drawing: 1, reaction kettle; 2, steam generator; 3, steam recovery apparatus; 4, steam pipeline; 5, pressure sensing device; 6, feed port; 7, discharge port; 8, discharge conveying belt; 9, high-pressure air pipe; 10, high-pressure air valve; 11, air intake valve; 12, pressure relief valve; 13, temperature sensor; 14, exhaust gas purification device; 15, electric control system.

### DETAILED DESCRIPTION OF THE EMBODIMENTS

In order to deepen the understanding of the present disclosure, the present disclosure will be described in further detail below in conjunction with the embodiments. The embodiments are only used to explain the present disclosure and do not constitute a limitation to the protection scope of the present disclosure.

As shown in the drawing, in accordance with this embodiment, it is provided a dehydration and upgrading system for a high-water-content material, including a reaction kettle 1. A steam generator 2 and a steam recovery apparatus 3 are arranged beside the reaction kettle 1. The steam generator 2 and the steam recovery apparatus 3 are located at left and right sides of the reaction kettle 1 respectively, and are connected through steam pipelines 4. A pressure sensing device 5 is arranged on the reaction kettle 1 to sense the pressure in the reaction kettle 1. A feed port 6 is formed at an upper end of the reaction kettle 1. A discharge port 7 is formed at a lower end of the reaction kettle 1. A discharge conveying belt 8 is arranged below the discharge port 7. A high-pressure air pipe 9 is arranged on one side of the middle part of the reaction kettle 1, and a high-pressure air valve 10 is arranged on the high-pressure air pipe 9. An air intake valve 11 is arranged on the steam pipeline 4 on the steam generator 2 side, and pressure relief valves 12 are arranged on the steam pipelines 4 on the steam recovery apparatus 3 side. The feed port 6 and the discharge port 7 are provided with air-tight plugs used for increasing the airtightness of the feed port 6 and the discharge port 7 respectively. A temperature sensor 13 is arranged on the reaction kettle 1 to detect the temperature in the reaction kettle 1. The number of the steam pipelines 4 on the steam recovery apparatus 3 side is three, and each steam pipeline 4 is provided with the pressure relief valve 12. An exhaust gas purification device 14 is arranged between the steam generator 2 and the steam recovery apparatus 3. The steam recovered in the steam recovery apparatus 3 is treated through the exhaust gas purification device 14, and is then conveyed to the steam generator 2 for recycling. An electric control system 15 is arranged near the reaction kettle 1. The electric control system 15 controls each component.

The process of releasing from a high pressure to a low pressure in the reaction kettle 1 is transient, and thus the pressure and temperature differences between the coals inside and the outside are increased, so that the coal moisture is removed in two forms of flash evaporation and seepage flow, and the explosion energy breaks the pore structures and prevents the readsorption of water at the same time. The feed port 6 at the upper end and the discharge port 7 at the lower end of the high-pressure reaction kettle 1 are both provided with high-pressure sealing devices to satisfy the sealing property and the safety during operation of the equipment under high-temperature and high-pressure conditions. Sealing valves connected between different platforms have higher airtightness and need to be closed during dehydration. Air-tight plugs are arranged at an inlet of the feeding platform and an outlet of the discharging platform. The air-tight plugs are opened during feeding and discharging, and are hermetically closed during operation of the equipment. The high-pressure reaction kettle is provided with the temperature sensing device 13 and the pressure sensing device 5, which can monitor temperature and pressure in the reaction kettle in real time respectively. The pressure relief valve 12 of the high-pressure reaction kettle 1 adopts a special valve that can quickly release saturated steam in an instantaneous state, so as to reduce the pressure and temperature in the system and ensure the dehydration effect. High-pressure air used by the discharging platform shall have high drying property, and protective gas is used to prevent spontaneous combustion of slime coal. The steam recovery apparatus 3 has good heat insulation property and can effectively keep waste heat generated by the system. The recovered steam returns to the steam generator 2 so as to realize recycling of the steam, which reduces the overall energy consumption. The exhaust gas purification device 14 can effectively filter out materials and dissolved ions brought out by the steam in order to ensure the purity of the steam.

What is claimed is:

1. A dehydration and upgrading system for a high-water-content material, comprising a reaction kettle, a steam generator and a steam recovery apparatus, wherein the steam generator and the steam recovery apparatus are located at left and right sides of the reaction kettle respectively, and are connected through steam pipelines; a pressure sensing device is arranged on the reaction kettle to sense the pressure therein; a feed port is formed at an upper end of the reaction kettle; a discharge port is formed at a lower end of the reaction kettle; a discharge conveying belt is arranged below the discharge port; a high-pressure air pipe is arranged on one side of the middle part of the reaction kettle; and a high-pressure air valve is arranged on the high-pressure air pipe.

2. The dehydration and upgrading system for the high-water-content material according to claim 1, wherein an air intake valve is arranged on the part of the steam pipelines on the steam generator side, and a pressure relief valve is arranged on the part of the steam pipelines on the steam recovery apparatus side.

3. The dehydration and upgrading system for the high-water-content material according to claim 1, wherein the feed port and the discharge port are provided with air-tight plugs for increasing the airtightness of the feed port and the discharge port respectively.

4. The dehydration and upgrading system for the high-water-content material according to claim 1, wherein a temperature sensor is arranged on the reaction kettle to detect the temperature therein.

5. The dehydration and upgrading system for the high-water-content material according to claim 1, wherein the number of the part of the steam pipelines on the steam recovery apparatus side is at least two, and each of the part of the steam pipelines on the steam recovery apparatus side is provided with the pressure relief valve.

6. The dehydration and upgrading system for the high-water-content material according to claim 1, wherein an exhaust gas purification device is arranged between the steam generator and the steam recovery apparatus; and the steam recovered in the steam recovery apparatus is treated through the exhaust gas purification device, and is then conveyed to the steam generator for recycling.

7. The dehydration and upgrading system for the high-water-content material according to claim 1, wherein an electric control system is arranged near the reaction kettle, and the electric control system controls each component.

8. The dehydration and upgrading system for the high-water-content material according to claim 2, wherein the number of the part of the steam pipelines on the steam recovery apparatus side is at least two, and each of the part of the steam pipelines on the steam recovery apparatus side is provided with the pressure relief valve.
